(19) United States
(12) Patent Application Publication
(10) Pub. No.: US 2025/0236013 A1
(43) Pub. Date: Jul. 24, 2025

(54) Mobile Robotic Arm System with Lifting Mast on Continuous Tracks

(71) Applicant: X-Hab 3D, Inc., State College, PA (US)

(72) Inventors: Nathan Watson, Port Matilda, PA (US); Sven Bilén, State College, PA (US)

(21) Appl. No.: 19/033,223

(22) Filed: Jan. 21, 2025

Related U.S. Application Data
(63) Continuation-in-part of application No. 63/622,477, filed on Jan. 18, 2024.

(51) Int. Cl. B25J 9/14; B25J 5/00; B25J 15/00; B33Y 30/00; E04G 21/04

(52) U.S. Cl. CPC B25J 9/144; B25J 5/005; B25J 15/0019; B25J 15/0066; E04G 21/0463; B33Y 30/00

(57) ABSTRACT

A mobile robotic arm system includes a mobile platform; a lifting mast mounted to the mobile platform; a generator on the mobile platform for powering electric and electronic components on the mobile platform; a hydraulic power unit mounted to the mobile platform for providing hydraulic power to the lifting mast; and a multi-axis robotic arm mounted on the lifting mast and powered by at least one of the generator and the hydraulic power unit. The system can be configured for off-grid operations wherein 3DCP operations can be conducted using solely components and materials on the mobile platform.

### CROSS REFERENCE TO RELATED APPLICATION

This application is a continuation-in-part of U.S. patent application No. 63/622,477 filed Jan. 18, 2024.

### FIELD OF THE INVENTION

The present invention relates to the field of autonomous construction, including 3D concrete printing (3DCP) and other construction-related tasks that can be performed via robotic arm, e.g., rebar placement, window and door placement, lintel placement, mechanical systems placement, material handling, welding and fabrication, assembly, painting and coating, inspection and monitoring, drilling, maintenance, repairs, etc. The invention comprises a multi-axis robotic arm mounted on a lifting mast integrated with a mobile platform on continuous tracks (e.g. caterpillar or tank tracks).

Systems and apparatus for 3DCP are known in the industry, and can be used to relatively quickly fabricate concrete walls. Such systems can be used to spread layers of concrete material in a desired pattern, and then spread further layers on top of the just placed layer, to create wall structures and the like. Systems such as this system are functional, but they cannot be brought to potentially remote locations as quickly as desired. Further, known systems have a limited field of reach around the platform supporting the 3DCP nozzle, or require substantial additional structure to be mounted over the build site.

### SUMMARY OF THE INVENTION

The disclosed invention is a mobile robotic arm system with lifting mast on continuous tracks designed to enhance reach, print area, versatility, and stability during autonomous construction processes, such as 3D concrete printing, as well as transportability to and from construction sites. The system includes a computer-controlled multi-axis robotic arm of variable length and payload capability, mounted on a lifting mast (i.e., forklift-style), which is affixed to a continuous-track mobile platform. The lifting mast is hydraulically or mechanically actuated, enabling variable extension of the reach of the robotic arm, increasing the system's build/access volume. The lifting mast is reinforced where necessary for additional stiffness, to reduce the degree of “wobble” of the end effector at the end of the robotic arm, due to the reaction forces at the base during acceleration or deceleration of the robotic arm during the printing process.

In one non-limiting configuration, a mobile robotic arm system comprises a mobile platform; a lifting mast mounted to the mobile platform; a generator on the mobile platform for powering electric and electronic components on the mobile platform; a hydraulic power unit mounted to the mobile platform for providing hydraulic power to the lifting mast; and a multi-axis robotic arm mounted on the lifting mast and powered by at least one of the generator and the hydraulic power unit.

In one non-limiting configuration, the lifting mast comprises a substantially vertical mast and a support structure moveable along the mast and extending laterally away from the mast, the multi-axis robotic arm being mounted to the support structure.

In another non-limiting configuration, the system further comprises a 3D concrete printing nozzle mounted to the multi-axis robotic arm and a 3D concrete printing system connected to the nozzle.

In still another non-limiting configuration, the 3D concrete system is mounted to the mobile platform.

In a further non-limiting configuration, the 3D concrete system comprises a water supply, a silo and a mixer pump all mounted on the mobile platform.

In a still further non-limiting configuration, the mobile platform comprises a vehicle body with a drive mechanism.

In another non-limiting configuration, the mobile platform further comprises a trailer connected to the vehicle body.

In still another non-limiting configuration, the drive mechanism comprises an engine or a motor, and a track system driven by the engine or the motor.

In a further non-limiting configuration, the track system comprises continuous tracks defining forward and reverse directions of movement, and the forward direction of movement defines what is referred to herein is a front or forward surface of the vehicle.

In a still further non-limiting configuration, the multi-axis robotic arm is positioned forward from a center of the mobile platform, whereby a build volume can be further away from the mobile platform, allowing for dynamic adjustment in height and depth relative to the build volume.

In another non-limiting configuration, the system further comprises additional tools interchangeable with the nozzle for at least one of rebar replacement, window and door replacement, lintel placement, mechanical systems placement, material handling, welding and fabrication, assembly, painting and coating, inspection and monitoring, drilling, maintenance, repairs, and combinations thereof.

In another non-limiting configuration, the system further comprises stabilizing supports on the mobile platform.

In still another non-limiting configuration, the stabilizing supports comprise a plurality of folding outriggers mounted to the mobile platform and movable between a deployed position wherein the mobile platform is stabilized on a surface, and a withdrawn position wherein they are within an overall outer profile defined by the mobile platform.

In a further non-limiting configuration, the mast is reinforced.

In a still further non-limiting configuration, the system further comprises a control system configured to communicate with controls on board the mobile platform, the mast and the robotic arm, and configured to move the mobile platform, control the mast, and control a tool implemented on the multi-axis robotic arm.

In another non-limiting configuration, the control system is remote from the mobile platform, whereby the system is remotely controlled.

In still another non-limiting configuration, in a position configured for storage or transportation, the system has a forward-facing profile defined by the mobile platform and the mast, and wherein the multi-axis robotic arm can be positioned to be fully within the forward-facing profile.

In a further non-limiting configuration, the system further comprises lift points on the mobile platform for use in air transportation of the system.

In a still further non-limiting configuration, the lifting mast is configured to lift the robot to a height above the mobile platform of at least 20 feet.

In another non-limiting configuration, the system further comprises survey tools on the mobile platform for surveying a potential worksite. The system, in coordination with survey tools including a robotic surveying tool, can survey the site as well as track the relative location of the system on site for precise robotic construction using reference points on the system.

### BRIEF DESCRIPTION OF THE DRAWINGS

A detailed description of preferred embodiments of the invention follows, with reference to the attached drawings, wherein:

FIG. 1 illustrates a system according to one embodiment of the invention;

FIG. 2 illustrates a system similar to that of FIG. 1, but with outriggers for stabilizing the system during an operation;

FIG. 3 illustrates a system according to the invention building a concrete structure;

FIG. 4 is a schematic top view illustrating area of reach for a system according to the invention, as well as a procedure where co-bots or two separate systems could be used;

FIG. 5 further illustrates a system according to the invention with robot arm and supports folded to a compact position; and

FIG. 6 shows a system according to the invention in the compact position partially loaded into a transport container;

FIGS. 7 and 8 illustrate a self-leveling feature wherein the mast can adjust to remain vertical while the mobile unit traverses uneven ground;

FIGS. 9 and 10 illustrate an alternative self-leveling feature wherein the robotic arm can be mounted to the forklift support through a self-leveling platform;

FIGS. 11a-11e illustrate different modular assemblies that can be configured with the system;

FIG. 12 illustrates power and control components of the system as disclosed herein;

FIGS. 13 and 14 illustrate a system having multiple robotic arms on a single platform;

FIG. 15 illustrates another version of a system as disclosed herein;

FIG. 16 illustrates a structure fabricated completely off grid using a system in accordance with the invention; and

FIG. 17 illustrates a system having lift connections for use in airlifting the system.

### DETAILED DESCRIPTION

The invention relates to a mobile robotic arm system with lifting mast on continuous tracks that is useful for autonomous construction including 3D concrete printing (3DCP) and other construction-related tasks that can be performed by robotic arm. In embodiments, a self-contained system is disclosed that can be transported or driven to various locations including locations remote from typical construction support and, nevertheless, be useful for 3DCP construction.

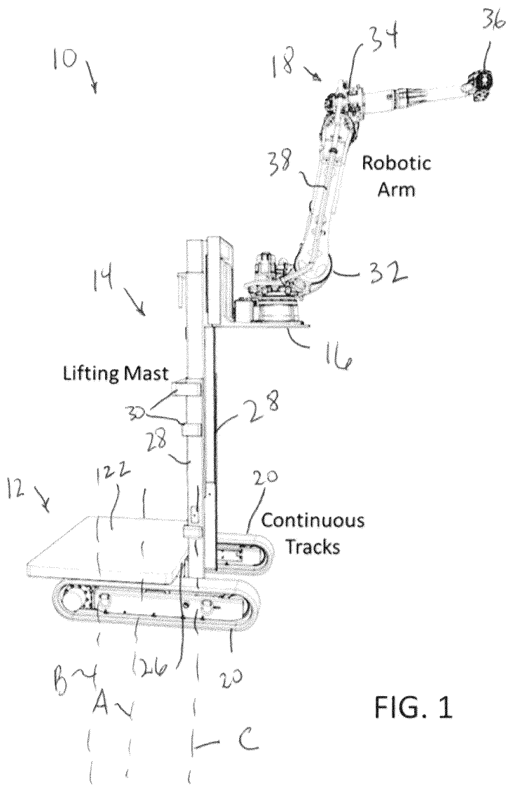

FIG. 1 shows a system 10 according to the invention having a mobile platform 12, a lifting mast 14, a forklift-like support 16 that is moveable along mast 14, and a robotic arm 18 that is mounted to the forklift support 16. In some non-limiting configurations, it is within the scope of this disclosure to mount the robotic arm 18 directly and moveably to the mast 14 without the need for forklift-like support 16. Any carriage can be used to mount robotic arm 18 to mast 14, and the example of such a carriage given in FIG. 1 is forklift-like support 16.

Platform 12 can be a mobile platform mounted on a conveyance device such as continuous tracks 20. Other conveyances such as wheels or the like are within the broad scope of this disclosure, but continuous tracks 20 can advantageously allow the system to traverse rough surfaces such as may be present in rural areas and/or areas that have had a weather-related or other event, and can advantageously be configured to produce surface pressure of less than 8 psi, which greatly expands the areas to which the device can be navigated.

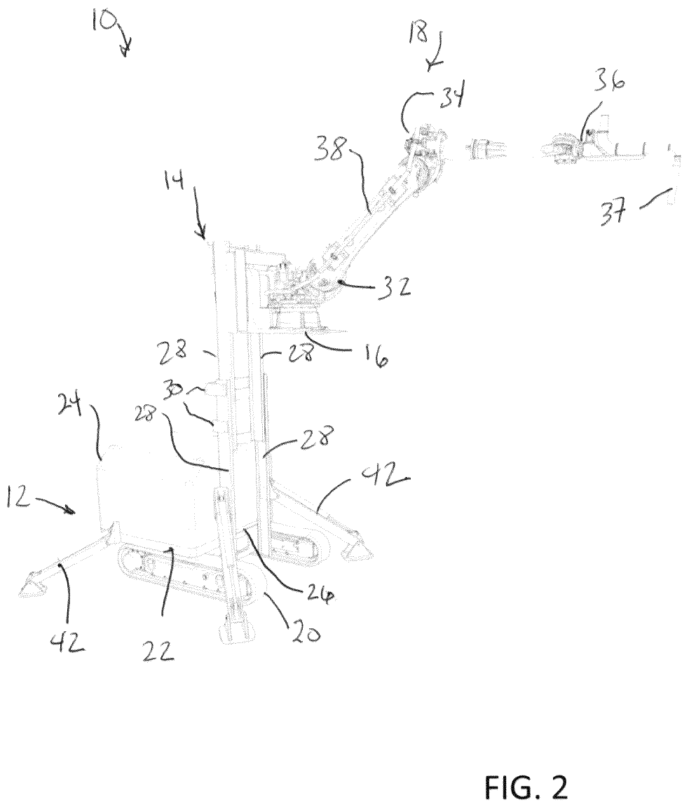

A platform 22 or other support structure can be positioned on mobile platform 12, for example covering a motor, engine or other motive unit (not shown) of mobile platform 12 and/or connected to a chassis (not shown) of such a structure. Platform 22 can be used for mounting components of the system and may have a housing 24 (FIG. 2) to enclose such components.

Lifting mast 14 can be mounted to mobile platform 12, for example on a forward-facing surface 26 of mobile platform 12 and/or platform structure 22, for example a forward surface of platform 22. Mast 14 extends upwardly for a distance selected to allow robotic arm 18 to reach in a large sphere around mobile platform 12, and also to reach high enough levels to construct structures having substantial height. In this regard, mast 14 can be configured to elevate to a height of at least 20 feet above the platform 22 and thereby to be able to construct structures having two stories in height. Mast 14 can be fabricated from sturdy and/or reinforced materials. This is advantageous as it is desirable for robotic arm 18 to have little or no wobble as it is being used to carry out various construction tasks, especially when carrying out 3DCP tasks. In the configuration shown in the drawings, mast 14 is formed of two laterally spaced support members or rails 28, which can have one or more reinforcements 30 mounted thereon.

Forklift support 16 can be mounted to mast 14 for movement along mast 14, from a position at a top of mast 14 on a high end to a position between continuous tracks 20 at a low end. Forklift support 16 can be moved along mast 14 with numerous mechanisms such as electric motors, pneumatic and/or hydraulic drives and the like.

In addition, as is evident in FIG. 2, supports 28 of mast 14 can comprise two or more telescoping sections to enhance the vertical reach of mast 14. Thus, forklift support 16 can be moved along lifting mast 14, and lifting mast 14 itself in this embodiment can be telescoped to lengthened or shortened height as desired.

Robotic arm 18 can be a multi-axis robotic arm mounted to forklift support 16 as shown in FIGS. 1 and 2. Robotic arm 18 can have a first pivot joint 32 and a second pivot joint 34, and arm 18 can also swivel at one or more locations such that arm 18 has multi-axis or multi-axle movement capability. A terminal or distal end 36 of arm 18 can be used to support tools as necessary to carry out the desired construction-related tasks. For example, end 36 can be configured to support a nozzle for 3DCP (see nozzle 37, FIG. 2), arm 18 being configured to move the nozzle along a surface on which 3DCP is to be carried out. End 36 can also be configured to support numerous other tools such as are described above and herein. For the configuration in which 3DCP is carried out using system 10, cables and/or tubes 38 and other devices are disposed along arm 18. These cables and other devices serve to produce movement of different segments of arm 18 as desired, and to provide electrical, data, hydraulic, compressed air, and/or material flow connections to tools supported by arm 18 as needed.

The configuration as described in connection with FIGS. 1 and 2 positions mast 14 and robotic arm 18 spaced away from a center of mobile platform 12 and also away from a center of gravity of mobile platform 12. This allows greater stability and reach for robotic arm 18, thereby expanding the work radius that can be reached.

In FIG. 1, a center of mobile platform 12 is shown at vertical axis A whereas a center of gravity of mobile platform 12 is shown at vertical axis B. In this regard, center of gravity (axis B) could in some instances coincide with physical center (axis A), or could be spaced in either direction from axis A, depending upon the weight and position of motor/engine and other components within housing 24 (FIG. 2) and the weight and position of components on arm 18. In any event, vertical axis C of mast 14 is spaced from both axes A and B in a forward direction when considering the forward direction of movement of mobile platform 12. Considered another way, a front facing portion of the forklift support 16 can be considered as a front of the vehicle or system 10.

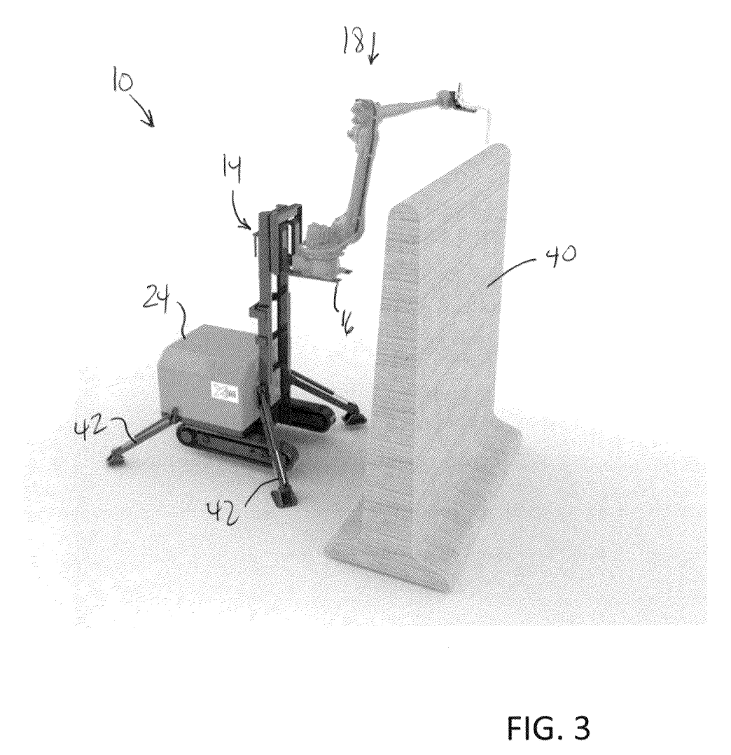

FIG. 3 shows system 10 in the process of constructing a concrete wall 40. Consecutive layers of concrete are applied to wall 40 as controlled by programming for the 3DCP system, and it should be appreciated that many structures can be fabricated in this manner. Further, the mounting of robot arm 18 on forklift support 16 that is in front of mast 14 allows forklift support 16 to be lowered much further than it could be if mounted differently, and this allows greater reach at levels below system 10 as well.

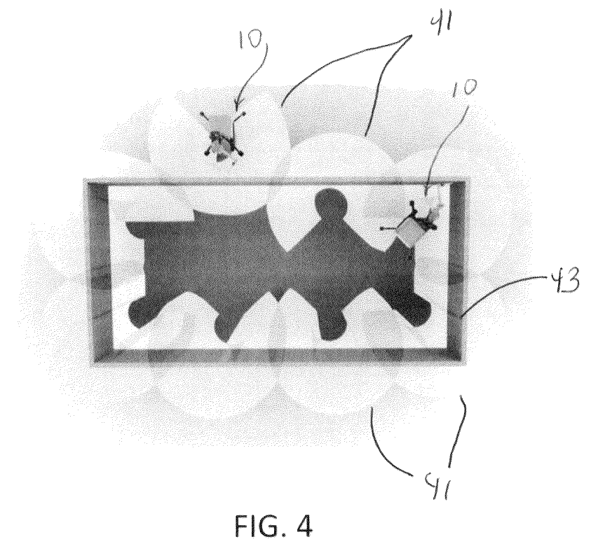

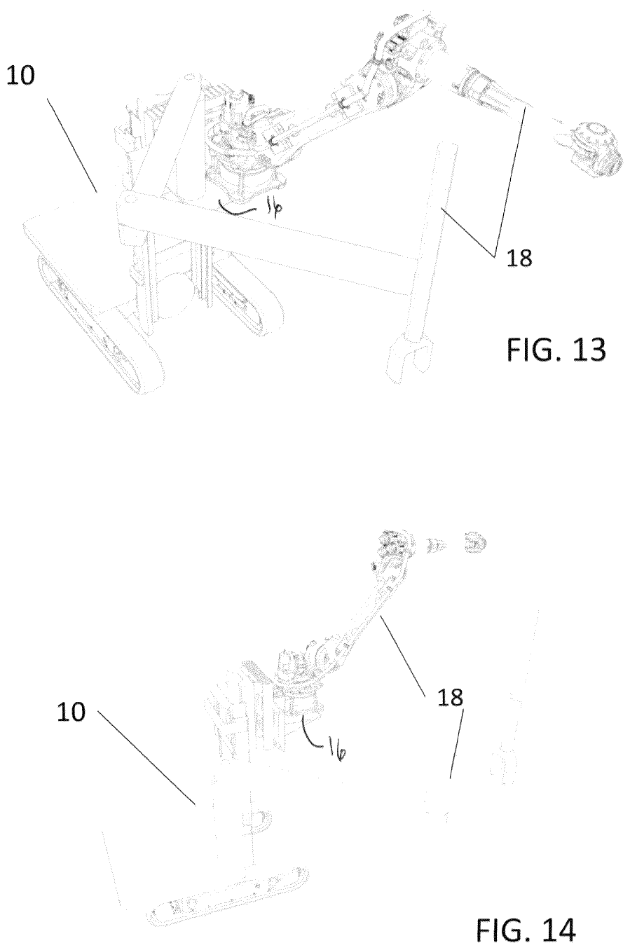

FIG. 4 shows different positions of a system 10 and a radius 41 or sphere of reach for each position. In this illustration, the rectangular structure 43 can be fabricated from a total of eight (8) positions, all of which would be readily accessible to system 10 on mobile platform 12 as described above. In addition, it should be appreciated that with either multiple systems 10 as shown (2 shown in FIG. 4), or with multiple robotic arm units mounted on a single platform (FIGS. 13 and 14 discussed below), complex procedures can be carried out, such as following a layer of concrete with mesh screens, as one non-limiting example.

As noted above, system 10 allows for extended reach with lifting mast actuation. Hydraulic, mechanical or electromechanical actuation of the lifting mast extends the reach of the robotic arm and enables cantilevering, surpassing the limitations of mounting the robotic arm directly to the mobile platform or via a non-mast type lifting mechanism under the robot base. By moving the lift mechanism from a position under the robotic arm to a position behind it allows for the minimum height of the robot to be well below the height of the retracted lift mechanism and enables the lift mechanism to be the same height as the total height of the vehicle. This feature facilitates the 3D printing of taller structures and below-ground structures, accommodating diverse construction requirements. This also brings the robot forward, which allows working on a build volume further away from the mobile platform. This uniquely allows for dynamic adjustments in both height and depth on a mobile 3D concrete printing system during the printing process.

In addition, and as set forth above, system 10 as disclosed herein provides for an expanded semi-spherical print area. The use of a robotic arm creates a semi-spherical print volume centered at the base of the robot. This creates a larger build area cross-section closer to the mid-plane of the sphere. Using the lifting mast along the full print height, including low to the ground, the largest build area can be used during the print's full height, thus minimizing the number of sections needed for a given structure. Limiting the robot's height at the bottom or top of the print height limits the print cross-sectional area to the smallest cross-section within the full height, limiting it to the cross-section farther from the mid-plane.

Also as noted above, system 10 provides for stability optimization. The robotic arm, lifting-mast mechanism, and continuous-tracked mobile platform are collectively designed, engineered, and integrated as a single system, to optimize stability throughout its reach volume during acceleration and deceleration phases, resulting in an expanded printing area with respect to the mobile platform's stationary position, and precise concrete deposition in the 3D printing process.

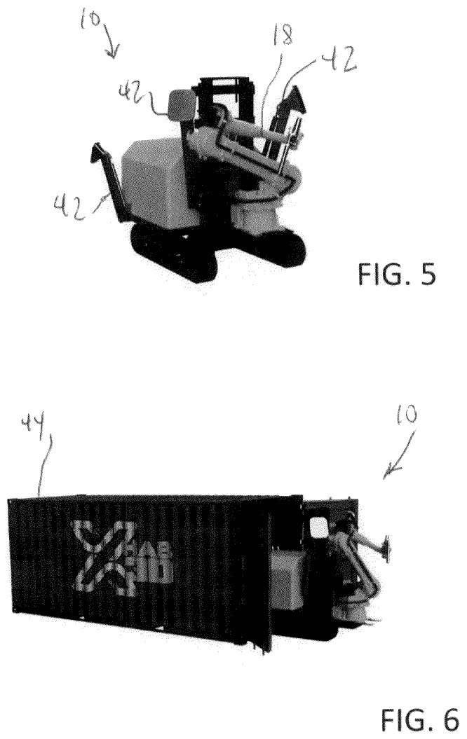

In a further configuration, illustrated in FIGS. 5 and 6, system 10 has a compact, foldable design. The entire system is engineered with a compact, foldable design, allowing for efficient collapsing onto itself without disassembly, facilitating easy set up and packaging, and substantially reducing the overall footprint for transportation. As shown in FIG. 5, from a front profile of system 10, robot arm 18 folds to within the front surface area of system 10. The same is true for outrigger supports 42 (also shown in FIG. 2). Thus, as shown in FIG. 6, system 10 in the compact position can fit within a shipping container 44. These container-friendly dimensions allow system 10 to fit inside a standard shipping container 44, fully assembled. This design consideration simplifies logistical challenges and facilitates cost-effective shipping to construction sites worldwide.

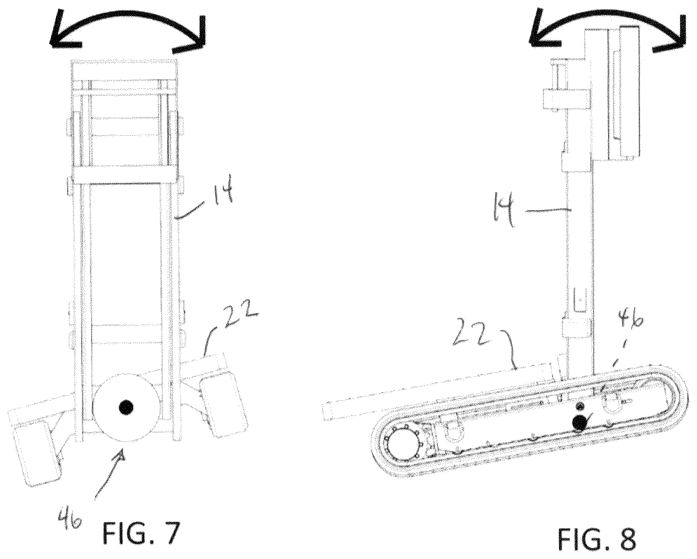

FIGS. 7 and 8 illustrate a further non-limiting embodiment wherein lifting mast 14 can be mounted to platform 22 through a joint structure 46 that can allow pivot of mast 14 relative to platform 22 such that mast 14 can be kept vertical while platform 22 and mobile platform 12 may need to traverse uneven ground. As shown, joint structure 46 can provide for pivot of mast 14 side-to-side as shown in FIG. 7, or front-to-back as shown in FIG. 8, or both.

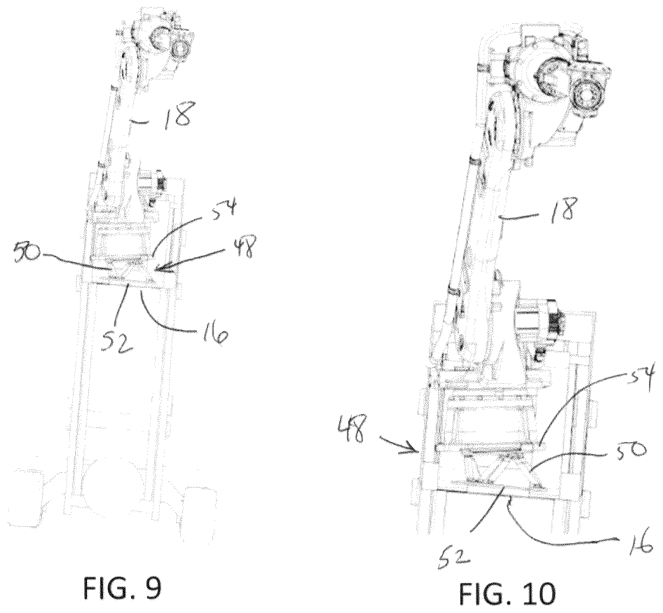

FIGS. 9 and 10 illustrate a further non-limiting configuration wherein robot arm 18 can be mounted to forklift support 16 through a leveling device 48. Leveling device 48 can have a series of arms 50 pivotably connected and extendible between a lower platform 52 and an upper platform 54 to allow leveling of the upper platform 54 relative to the lower 52.

Further, it should be appreciated that mounting of outrigger supports 42 directly to mast 14 as shown in FIGS. 2 and 3 allows for further stabilization and self-leveling by providing direct support to the mast rather than through platform 22.

As disclosed herein, the mobile platform 12 incorporates a forklift-style mast lift mechanism (z-axis) with an integrated self-leveling capability (e.g. FIGS. 7-10). This mechanism includes retractable outriggers 42 attached to the mast 14 in the front of the mobile platform 12, and attached to the mobile platform 12 itself in a rear of the mobile platform 12, allowing for leveling of both the mast 14 and the mobile platform 12. As used in this drawing, front is toward the location of mast 14 relative to mobile platform 12, and rear is away from the location of mast 14 relative to mobile platform 12. The degree of leveling is determined by the slope grade of the surface on which the platform is positioned.

In addition to the outriggers 42, the mast 14 itself possesses self-leveling capabilities (again, FIGS. 7-10). This self-leveling can be achieved either through the entire mast self-leveling or by having the base of the mast self-level while the rest of the mast is positioned at a different angle. This angle may be perpendicular to the base of the mobile platform, although this is not required.

This design is particularly critical in scenarios where the mobile platform is situated on uneven or steep terrain, such as the side of a hill or mountain. In such cases, traditional leveling methods involving the mobile platform or outriggers may prove ineffective. The innovative design disclosed herein ensures that any tool or equipment, like a robotic arm, placed on the base of the lift mechanism, is automatically leveled. This automatic leveling feature remains effective even if the mobile platform maintains a non-level angle. As a result, the system provides enhanced stability and functionality, making it adaptable to challenging terrain conditions.

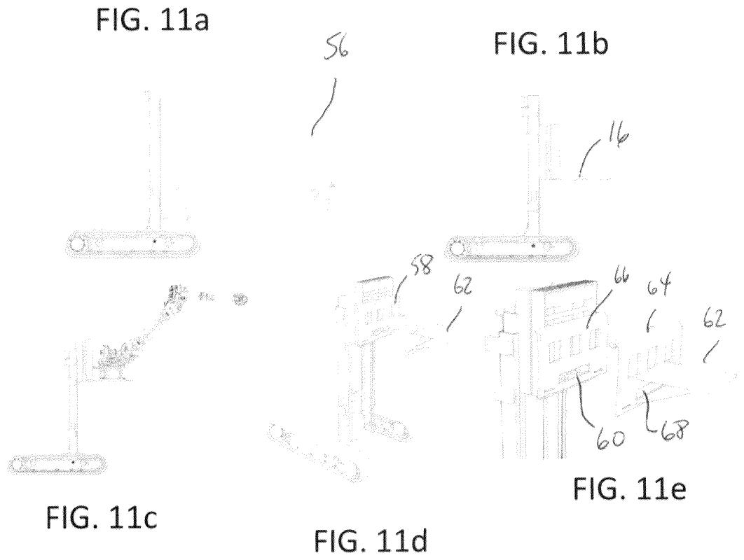

In another non-limiting configuration, system 10 can be modular in construction to allow for various different functionality to be implemented. FIGS. 11a-11e illustrate this modularity, wherein FIG. 11a shows mobile platform 12 with an excavator arm 56 attached thereto. FIG. 11b shows a configuration with forklift support 16 as disclosed in other embodiments. FIG. 11c shows this same configuration with a robot arm 18 mounted on forklift support 16. FIGS. 11d and 11e show system 10 with a mounting plate 58 for forklift support 16 or other components, and mounting plate 58 can have a number of connections 60 for electrical, hydraulic, mechanical and other connections from control components of the system to the tool units mounted on forklift support 16. In this regard, to allow for ease of connectivity, support component 62 of forklift support 16 can have a front plate 64 that makes contact with plate 66 mounted to mast 14. Front plate 64 can have an opening 68 positioned to overlie connections 60 such that components supported on component 62 can be readily connected to connections 60 by passing cables, hoses, and/or wires through opening 68.

It should be appreciated that system 10 as disclosed herein represents a pioneering innovation, seamlessly integrating stability, reach, and portability into a compact design. The unique features and claims underscore the exceptional utility and distinctiveness of this system in the realm of 3D concrete printing.

With the modular configuration as disclosed, it should be appreciated that system 10 can serve as a fork-lift style lift mechanism attached to an automated mobile platform, with a standard interface at the base of the lift mechanism (with connectors to hydraulics, power, computer controls, sensors, etc.) for easily attaching, detaching, and replacing one construction tool with another, to enable the same mobile platform to support a range of applications on a construction site. This attaching, detaching and replacing can be performed manually or autonomously. Examples include, but are not limited to: excavator arm attachment for digging and moving earth; a hammer for breaking and demolishing concrete or rocks; and auger, for example used for drilling holes in the ground for various purposes; a grapple attachment which can, for example, enable the lifting and handling of bulky materials such as logs or debris; a power saw such as a circular saw or reciprocating saw for cutting various materials; a jackhammer for breaking up hard surfaces like concrete; a welding unit that for example allows on-site welding for repairs and construction tasks; a drill press for example having a stationary drill for accurate and consistent hole drilling; a telescopic boom attachment that can extend the reach of the lift mechanism for tasks requiring a longer reach; a concrete or adhesive dispenser which can enable precise dispensing of materials during construction; a concrete (e.g., shotcrete) sprayer; and finishing tools for interior finishing tasks, such as painting, plastering, or installing ceiling panels.

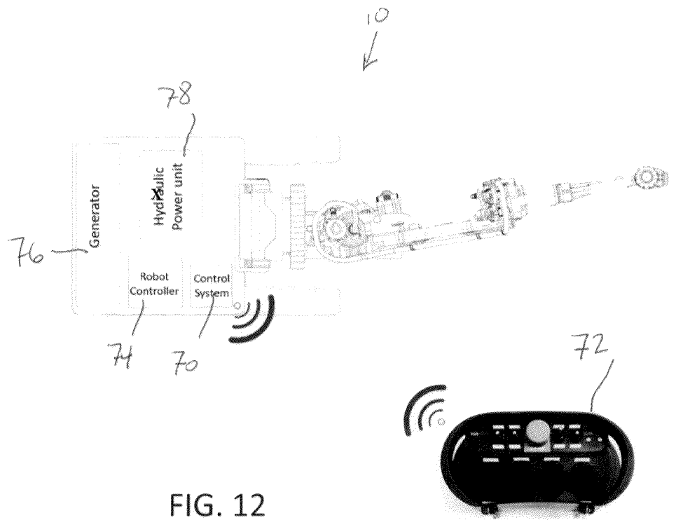

FIG. 12 shows a top view with one configuration of a control components for system 10 according to the invention. As shown, system 10 can have a control system 70, which can act to communicate with a remote controller 72 operated by an individual in charge of operating system 10. Control system 70 and controller 72 can function using any wireless protocol that would be well known to persons skilled in the art. Control system 70 can be communicated with a robot controller 74, a generator 76 and a hydraulic power unit 78. Robot controller 74 can be configured to translate instructions from remote controller 72 and send control signals to robotic arm 18. Generator 76 can be any suitable mechanism for generating electric power or the like, and for example could be connected to a conventional engine or motor on system 10. Finally, hydraulic power unit 78 could be one or more pumps and other mechanisms to utilize hydraulic pressure to bring about movement or operation of various components of the invention. Each of these components would typically comprise known hardware and software installed on the hardware to drive the desired function.

FIGS. 13 and 14 illustrate another non-limiting configuration wherein a single system 10 has multiple robotic arms 18 as discussed above, which can be utilized to perform complex procedures with one arm following the other, for example, or performing a parallel operation in a different location. FIGS. 13 and 14 illustrate an embodiment having a different type of robot arm on each of two different robot arms 18 mounted on forklift support 16. In the configuration of FIG. 13, both arms are mounted to forklift support 16, one to a top surface and the other to a bottom surface of support 16. In the configuration of FIG. 14, the second robot arm 18 is not mounted to support 16, but rather is mounted to mobile platform 12.

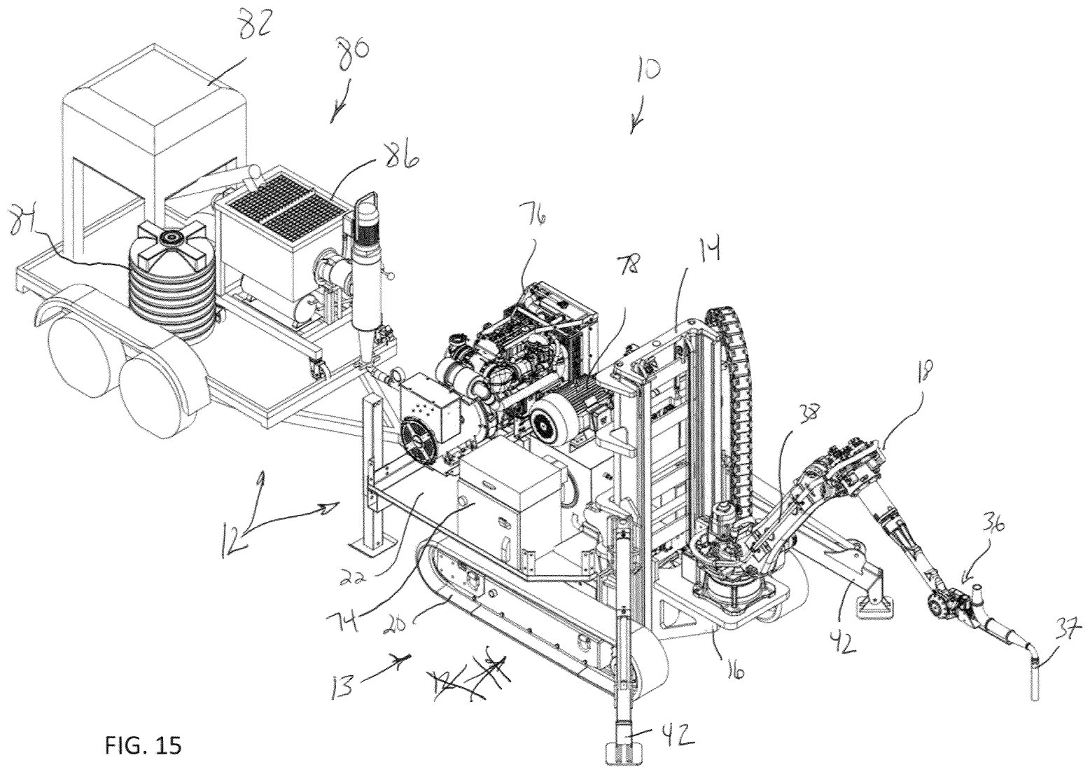

FIG. 15 shows another non-limiting configuration or embodiment wherein system 10 includes a mobile platform 12 that is self-contained and therefore can be used off the grid to bring all that is necessary to perform 3DCP and other construction steps without any infrastructure at the work site. FIG. 15 shows mobile platform 12 in two components, the first being the track-driven structure 13 as has been discussed above. In this case, however, in addition to the track-driven structure 13, there is a trailer portion 80. The various components and/or raw materials that are necessary for the entire process are mounted on either the track driven structure 13 or trailer 80, or both. In the configuration shown, robot controller 74, generator 76, and hydraulic power unit 78 are mounted to mobile platform 12, specifically to track driven structure 13. In the meantime, a silo 82 for dry materials or products can be mounted to trailer 80, as can be a water storage tank 84 and a mixer pump 86. These components can be used to generate a suitable liquid mixture for dispensing during a 3DCP process. Trailer 80 can be a wheeled vehicle as shown, or itself could be on tracks or any other suitable conveyance structure. Further, trailer 80 can be hooked to the rear portion of mobile platform 12 using a standard trailer hitch or tow hook structure. It should also be appreciated that more than one trailer 80 can be utilized and hooked up to track driven structure 13. Each of the trailers 80 can carry materials needed for functioning off the grid, i.e., for functioning entirely with materials and tool stored on or within track-driven structure 13, or one or more trailers 80.

Summarizing the various aspects of the disclosed embodiments above, the system as disclosed herein has mobility; can be pre-assembled off-site, for example for off-grid operations; has wide operating conditions; and can be integrated with other tools such as surveying tools. Survey tools on the mobile platform for surveying a potential worksite. The system, in coordination with survey tools including a robotic surveying tool, can survey the site as well as track the relative location of the system on site for precise robotic construction using reference points on the system.

For mobility, the unit is self-powered and remote controlled allowing the machine to navigate without the need to have an operator on or adjacent to the machine. The mobile system uses continuous tracks that allow it to navigate rough terrain, steep slopes, and soft ground requiring a surface pressure of less than 8 psi.

The system is designed to fit inside of a high cube box, such as a Conex box, or shipping container. Further, the system can be optioned with lift points and ATTLA certification for air transport on military aircraft. The system can also load and unload itself, or be directed through such a maneuver remotely, on the back of a flatbed trailer and/or towed by a heavy-duty pickup truck.

In connection with pre-assembly off-site, there can be a diesel generator on board with capacity to power the mobile unit itself, the robot, the mixing and pumping equipment, accessories, and other automated construction implements with a generator total capacity of, for example, 38 kW continuous. Thus, before approaching the work site, the system as disclosed herein can be fully equipped or stocked with all components and materials necessary to 3DCP build structures. In addition, the system can be configured to accept off-unit power as a backup and distribute it to the required equipment. The system can drive pre-assembled without requiring hands on assembly and set up. The system can tow a mixer pump, a silo of material, and the water and admix needed to print without the need of any additional utilities or support of existing infrastructure. The system is also designed to operate alongside equipment that can source local material to print using local aggregate. The system also includes a lifting mast to expand the reach of the industrial robot up above 20 ft to print two stories.

As to the broad operating conditions, the machine is protected from the weather and elements such that it can operate outdoors in various weather conditions including operating in precipitation and in temperatures ranging from extreme cold to extreme heat.

It is also possible to integrate surveying tools into the system. Such survey tools including a total station can be integrated to survey a new site and precisely position the mobile unit anywhere onsite for concrete printing or other autonomous construction jobs on site. Software can be used to design structures based off on-site measurements.

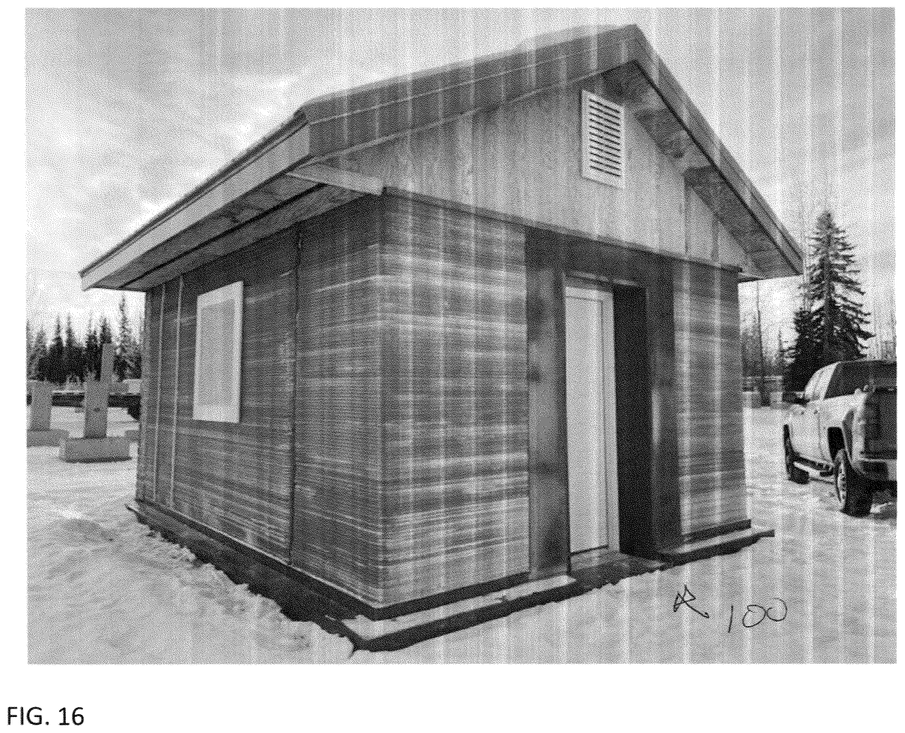

FIG. 16 illustrates results obtained using a system according to the invention to construct a structure completely off grid in Alaska. As shown the results are in the form of a structure 100 wherein the walls are built up of layers of cement printed using 3DCP process as outlined herein. As seen, the result is a sturdy structure constructed entirely from a system such as that illustrated in FIG. 15.

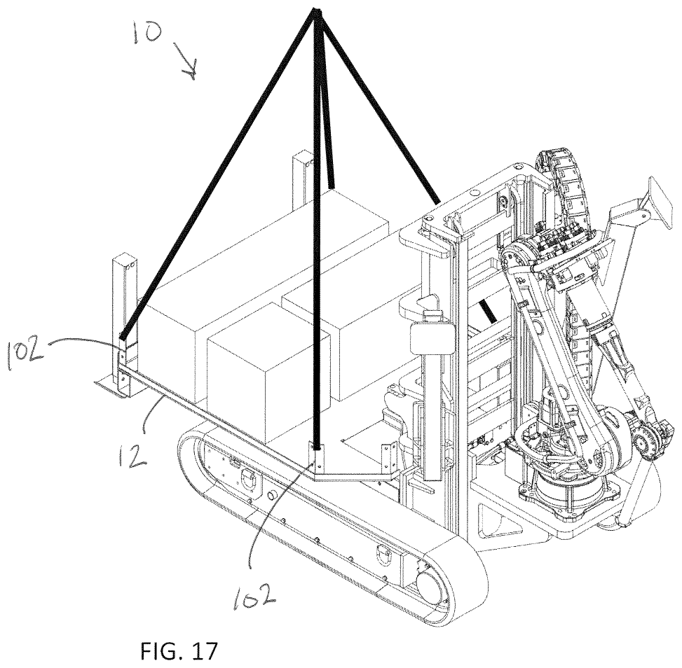

FIG. 17 illustrates a further non-limiting configuration of a system as disclosed herein, with a plurality of lift points 102 at spaced locations around mobile platform 21. These lift points 102 can be any suitable attachment structure to which tethers, ropes, belts or other such items can be connected for use in lifting system 10. These can be used to render system 10 capable of being transported by airlift, for example.

It should be appreciated that numerous embodiments and configurations have been disclosed above. These embodiments are to be considered non-exclusive, and can function together or independently. Further, while specific embodiments have been disclosed herein, it should be appreciated that modifications to the disclosed embodiments will become readily apparent to persons skilled in the art. Thus, the detailed description should be considered in all respects to be exemplary and not limiting upon the scope of claims as attached hereto.

We claim:

1. A mobile robotic arm system, comprising:
a mobile platform;
a lifting mast mounted to the mobile platform;
a generator on the mobile platform for powering electric and electronic components on the mobile platform;
a hydraulic power unit mounted to the mobile platform for providing hydraulic power to the lifting mast; and
a multi-axis robotic arm mounted on the lifting mast and powered by at least one of the generator and the hydraulic power unit.

2. The system of claim 1, wherein the lifting mast comprises a substantially vertical mast and a support structure moveable along the mast and extending laterally away from the mast, the multi-axis robotic arm being mounted to the support structure.

3. The system of claim 1, further comprising a 3D concrete printing nozzle mounted to the multi-axis robotic arm and a 3D concrete printing system connected to the nozzle.

4. The system of claim 3, wherein the 3D concrete system is mounted to the mobile platform.

5. The system of claim 4, wherein the 3D concrete system comprises a water supply, a silo and a mixer pump all mounted on the mobile platform.

6. The system of claim 1, wherein the mobile platform comprises a vehicle body with a drive mechanism.

7. The system of claim 6, wherein the mobile platform further comprises a trailer connected to the vehicle body.

8. The system of claim 6, wherein the drive mechanism comprises an engine or a motor, and a track system driven by the engine or the motor.

9. The system of claim 8, wherein the track system comprises continuous tracks defining forward and reverse directions of movement.

10. The system of claim 9, wherein the multi-axis robotic arm is positioned forward from a center of the mobile platform, whereby a build volume can be further away from the mobile platform, allowing for dynamic adjustment in height and depth relative to the build volume.

11. The system of claim 3, further comprising additional tools interchangeable with the nozzle for at least one of rebar replacement, window and door replacement, lintel placement, mechanical systems placement, material handling, welding and fabrication, assembly, painting and coating, inspection and monitoring, drilling, maintenance, repairs and combinations thereof.

12. The system of claim 1, further comprising stabilizing supports on the mobile platform.

13. The system of claim 12, wherein the stabilizing supports comprise a plurality of folding outriggers mounted to the mobile platform and movable between a deployed position wherein the mobile platform is stabilized on a surface, and a withdrawn position wherein they are within an overall outer profile defined by the mobile platform.

14. The system of claim 1, wherein the mast is reinforced.

15. The system of claim 1, further comprising a control system configured to communicate with controls on board the mobile platform, the mast and the robotic arm, and configured to move the mobile platform, control the mast, and control a tool implemented on the multi-axis robotic arm.

16. The system of claim 15, wherein the control system is remote from the mobile platform, whereby the system is remotely controlled.

17. The system of claim 1, wherein, in a position configured for storage or transportation, the system has a forward facing profile defined by the mobile platform and the mast, and wherein the multi-axis robotic arm can be positioned to be fully within the forward facing profile.

18. The system of claim 1, further comprising lift points on the mobile platform for use in air transportation of the system.

19. The system of claim 1, wherein the lifting mast is configured to lift the robot to a height above the mobile platform of at least 20 feet.

20. The system of claim 1, further comprising survey tools including a robotic surveying tool on the mobile platform for surveying a potential worksite, whereby the system can survey the site as well as track a relative location of the system on site for precise robotic construction using reference points on the system.
